(19) United States
(12) Patent Application Publication
(10) Pub. No.: US 2004/0049345 A1
(43) Pub. Date: Mar. 11, 2004

(54) Distributed, collaborative workflow management software

(76) Inventors: James G McDonough, Newbury Park, CA (US); Robert H Torchon, Moorpark, CA (US); Matt Savage Walton, Santa Monica, CA (US); William H Crooks, Thousand Oaks, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/311,449

(22) PCT Filed: Jun. 18, 2001
(86) PCT No.: PCT/US01/19532

(51) Int. Cl. G01V 1/40

(52) U.S. Cl. 702/12

(57) ABSTRACT

A system(11) architecture, and method for creating, storing, managing, accessing, communicating and displaying command, control and management information, to include text documents, tables, static map data and geographically reference dynamic data for the management of incidents or events by distributed, ad-hoc groups are described herein. The static map data may include, for example, cartographic data in digital format such as terrain data or street data. The dynamic data may include text, documents, tables, icons, and other symbology that graphically represent current status information (e.g., the current location of an incident, a resource, or the status of a facility). The system (11) includes one or more client subsystems (16, 17, 18, 19) running purpose-built and/or conventional software applications that communicate with a server subsystem (11) and can independently request, receive, store, and subsequently display the static map data and/or the dynamic data in document, tabular or graphical form. The display might include representing the dynamic data in graphical form either separately as tables and reports, or as an overlay on the static map data.

### FIELD OF THE INVENTION

The present invention relates to the field of creating, storing, accessing, communicating, and displaying enterprise management data, command and control information, static map data, such as terrain or street data, and geographically-referenced dynamic data in graphical or tabular format (e.g., icons, symbology, textual reports or forms) utilizing purpose-built software applications and/or conventional web servers and browsers. More specifically, the invention utilizes a networked computer system, architecture, and method to achieve rapid access to, and updates of, enterprise and incident command and control data, to include geographically referenced dynamic data. The invention operates by separating communication of the dynamic data from the communication of the associated static map data, and by leveraging the inherent local processing capabilities of networked client devices running purpose-built or conventional browser applications.

### BACKGROUND OF THE INVENTION

1.0 Distributed Enterprise and Workflow Management Systems

Many distributed enterprise and workflow management systems exist at various levels of scale including some quite large variants that accommodate many users. Such systems are typically built on top of “back-office” or “enterprise” software frameworks. These systems allow multiple users to access a central server or servers containing one or more databases. While connected the users may input, modify or extract information stored within the databases. These systems also perform predetermined tasks and guide users through these tasks by providing indications of which particular actions a user may, or is required to, perform at each point in a given task. Some systems incorporate mobile, intermittently connected users, which are typically general-purpose computers that periodically connect to a server via a modem or similar device.

Current enterprise and workflow management systems are frequently narrowly focused and purpose-built, supporting the performance of only one type of, or a limited set of, tasks (e.g., processing of purchase orders) related to a limited type of information (e.g., database records detailing purchase orders). The ability to work with a wide variety of data types integrated into an even wider variety of tasks would be a significant benefit in managing rapidly changing and unpredictable situations.

There exists a need for a system that fully integrates dynamic, geo-referenced, multi-media enterprise and incident command and control data and the tools of distributed collaborative workflow management systems while allowing mobile users full two-way exchange of both new and existing cross-referenced, dynamic, geo-referenced, multimedia data. The system should provide a generic set of tools to be used in support of the performance of any number of simultaneous tasks. Thus, a user operating from a “home office” information management system might combine several elements of multimedia geographically-referenced data, package them as an integrated data set and provide server access to the integrated data set by mobile wired or wireless users in a bandwidth-efficient manner. The system should also facilitate the synchronization of data newly collected in the field with data already stored at the home office and simultaneously allow the mobile user to reach the home office server for additional information created or updated by the home office or other mobile users.

2.0 Document Locking, Monitoring and Automatic Unlocking

One function of distributed enterprise workflow management systems is to synchronize files stored locally on each user's computer with other versions of the files stored in the database(s) located on the servers. In many instances access to the information stored in such systems is governed by locking mechanisms that allow only one user at a time to access and modify (“check out”) each document or piece of information. Rules embedded in the system as particular system configurations specify which users are allowed check out a given document or data record. In some systems a version of the document or record which may be read but not checked out continues to be available for simultaneous viewing by many users even when the document or data record is checked out and locked

Problems arise when users are only intermittently connected to the servers due to unreliable network connections or other circumstances. In these instances documents checked out by an intermittently connected user may remain unavailable for checkout by other users due to the locks attached to them when they were initially checked out. These locks normally remain in place until the user who has the document checked out checks the document back into the system thereby releasing the locks. Such schemes generally do not accommodate the occurrence of problems on the part of a remote user that checks out a document and then subsequently loses his or her connection to the server. When this happens the document remains checked out and is unavailable for update by any user until the user who checked the document out is able to reconnect to the system and check the document in. In rapidly changing environments where the accuracy and timeliness of information is of the utmost importance, such indeterminate spans where information cannot be updated are unacceptable. Where the information managed by the system is highly dynamic and particularly where it relates to matters of public health and safety such as emergency management, the lives of the public may depend upon quick access to and the accuracy of the information.

Automatic monitoring of such occurrences within the enterprise or workflow management system and a mechanism to release the lock placed on the document so that it will be available to other potential users after a reasonable time interval are needed. Without these, enterprise and workflow management systems are unsuitable for use in dynamic environments such as emergency and tactical operations where large numbers of users whose equipment and Internet connection reliability are unpredictable.

3.0 Mobile, Wireless Computing

A variety of devices, software, and communications systems exist that enable wirelessly connected, mobile users to utilize highly portable devices including lap-top computers, Personal Digital Assistants (“PDAs”) and data-enabled telephones and pagers to execute computer programs in the field and to exchange digital information wirelessly. The software systems may include Internet email or web-browser software, Personal Information Management (“PIM”) software (including voice annotation), typical office applications, GIS applications including on-board Global Positioning System (“GPS”) self-locating hardware/software, and even photo storage, retrieval and display software. These software applications are independent of each other forcing users to launch and operate in one application and then close that application before and launching and operating in another. Data products produced by one application can sometimes be transferred to and incorporated into data products produced by another application. What is needed is a process and enabling software allowing a user to conduct all field operations in a single, integrated intuitive application environment that does not require them to understand or select particular software applications for particular tasks. Rather the system must allow a user to perform a set of operational tasks using the wireless mobile device, with the appropriate tools or software applications being presented at the appropriate steps during the performance of the task(s). Additionally, the devices need applications that allow static information to be locally stored and only dynamic data to be exchanged with a server.

4.0 Dynamic Geo-Referenced Operational Information

Creating maps has primarily been the province of cartographers, their end products were traditionally printed paper maps. In a disaster—or a battle—the situation on the ground changes very rapidly, but the ground itself does not. People need to know where they should go and where they should not. They need to know where critical resources are being placed and where threats or hazards have been identified. Such information is easy to convey graphically, but difficult to explain in words and numbers. The traditional approach of military and public safety agencies has been to provide all decision makers with copies of identical paper maps and to create transparent acetate overlays to be placed atop the paper maps and annotated with tactical information. Such tactical information might include, for example, boundaries, staging areas, danger zones, prescribed routes and the like. These acetate layers typically include registration marks at diagonally opposite corners that trace some prominent feature on the map or locate the intersection of easting and northing grid lines. Overlays drawn over one map could, thus, be picked up and taken to another map of the same scale showing the same area and aligned properly over that map using the registration marks. An overlay could be copied and distributed to multiple users and would be of value so long as each user already had any necessary underlying regional maps. Since these dynamic mark-ups were not written on the maps themselves, users could utilize the same map throughout an operation, changing only the overlays to reflect current tactical information.

Many computer applications exist which present both textual information (e.g., news articles, reports or forms) and associated map images (e.g., topographic or street maps). While the application software that creates and displays the textual information can be written in many computer languages (e.g., Lotus, C++ or Visual Basic), creation of the cartographic portion of the display typically requires the use of a specialized application often referred to as a computer-based Geographic Information System (“GIS”). GIS systems have been in use for many years and while they vary widely in capabilities and sophistication, all of them support at least some of the following functions: Entry and update of cartographic information in digital form including elevation, slope, vegetation, drainage, location of man-made objects, and any other information that may be generally related via a particular geographic location or coverage area. Creation and maintenance of geographically referenced databases including those which contain, demographics, assessor information, facilities inventories, etc. Answering queries of the system database with some combination of tabular and/or map displays. The map displays may consist of cartographic data and additional graphics that represent whatever database information was requested (e.g., shaded areas to show the percentage population of certain ethnic groups in specific geographic areas or symbols to show the location of all hospitals). Manipulation of map displays allowing the user to select the locations to be displayed and the scale at which they are displayed (pan, scroll and zoom utilities).

The vast majority of information content of computer-based displays of cartographic information is static and represents simply the original information supplied by the cartographer or the database developer at the time the map was created. In the paper and pencil world such information is printed and widely distributed in the form of maps, charts and the like. In the digital world this static information may be represented by very large collections of data and is difficult for relatively low bandwidth users to access and utilize in a timely manner. In either case if the map is intended for navigation only this static information is usually all that an end user will require.

However, static maps are increasingly being used as backgrounds for computer-generated displays over which rapidly changing dynamic information, in the form of icons or other graphic symbols, is placed. In contrast to the relatively large size of the static data, dynamic information contained in tactical overlays may be represented by a very small data set. In the paper and pencil world the dynamic information is customarily represented by the acetate overlays described above. GIS systems typically do not support a function equivalent to a tactical overlay. Instead cartographic data is organized into layers that represent a particular data type, for example, roads, rivers, vegetation, etc. Those GIS systems that do support overlays do so in the form of mark-up layers. A mark-up layer might contain, for example, a pictorial representation of all roads within the bounds of the map or a layer representing all graphical icons to be displayed on the map. Mark-up layers are normally treated as simply another layer of cartographic information and are handled in the same manner as static data.

Recently, several GIS programs have been developed that serve up map data to browser clients over the World Wide Web or over intranets. Typically these programs create a particular arrangement of map layers, which may include an icon layer, and transmit that information to browser clients as a single large graphic file. The impact of this methodology is that, if there is a change to any element of the map data (such as the location of a single icon), the entire graphic file must be re-transmitted to the browser clients to reflect that single change. Such large information exchanges usually demand high bandwidth connections that are unavailable to many users, particularly mobile users connected via public or private wireless networks. Users with access through only low or moderate bandwidth connections will experience long delays when they are forced to download a large graphic file upon each update of dynamic data. In a rapidly changing environment such delays are unacceptable and if the environment is, for example, one of disaster management, such delays may well be the difference between life and death of members of the public who depend directly or indirectly on the timely update of dynamic situational data. What is needed is a way for network-connected clients to share the latest dynamic data without requiring a complete retransmission of the far larger underlying static data.

5.0 Image Editing & Compression Software and Algorithms

Many software applications exist that allow the editing and compression of digital images. Each of them includes capabilities for manipulating image files in various ways, typically including the ability to reduce the size of the resulting file. However, the image manipulation capabilities of these applications are presented in isolation, rather than integrated into a single software application with the express purpose of allowing the user to select among alternative methods of data manipulation to minimize file size.

Image editing software is a broad class of applications that permit the user to manipulate digital image files in a wide variety of ways. The primary focus of this type of software is data manipulation that changes the content of the image (e.g., merging images; changing, enhancing, and/or eliminating selected image details; etc.). One of the capabilities of image editing software is file size reduction, which may be accomplished in several ways, including image size reduction, cropping (i.e., selectively removing a portion of the image), resolution reduction, and color depth reduction. Some examples of leading image editing software for personal computers include the following:

Adobe “PhotoShop”

Jasc “Paint Shop Pro”

Ulead “PhotoImpact”,

Microsoft “Photo Editor”

Image files (e.g., photographs, complex drawings) are normally stored on computers as bit maps. These describe every picture element (pixel) of an image. The higher the resolution of the image, the greater number of pixels required to describe it and the larger the size of the resulting image file. Image files are usually quite large compared to text files, a moderately high resolution image may be as large as a text file containing hundreds or even thousands of pages of text. This limits the ability of users connected to a network via low or moderate bandwidth connections such as telephone or wireless modems to exchange such bit-mapped images in an efficient and timely manner. Many algorithms have been devised to compress bit-mapped information, and a number of formats now exist that significantly reduce file size while minimizing image degradation. These data compression algorithms (and the resulting file types) include:

LZW (GIF)

JPEG (JFIF)

Data compression software has also been developed expressly for the purpose of compressing digital image files, including:

MrSID

Enhanced Compression Wavelet (ECW)

However, these compression algorithms and software are not optimized for the user to select among alternative file size reduction methods and to view in real time the results of the several methods to assure that the intended information is retained while minimizing file size and transmission time.

### SUMMARY OF THE INVENTION

The present invention includes a method for communicating geographically based data wherin the geographically based static data is stored at a user terminal, geographically based dynamic data is stored at a user terminal, the static and dynamic data are displayed together in an overlaid geographically coordinated fashion and the dynamic data is repeatedly transmitted to a user terminal together with the static data in an overlaid geographically coordinated fashion. The stored geographically based dynamic data may further be received from a central server. An input device may be used to select a landmark within the static data thereby causing the display of data about the landmark together with the static data and dynamic data in an overlaid fashion. In addition to viewing geographically based dynamic data, users may also input geographically based dynamic data to be stored at the user terminal. If a user chooses to input geographically based dynamic data at a user terminal, the dynamic data may be transmitted to a central server and from there further transmitted to other user terminals. Where the geographically based static or dynamic data is further transmitted to other user terminals is may also be stored by the other user terminals and displayed together in an overlaid geographically coordinated fashion. Further, updated dynamic data may be repeatedly transmitted to the other user terminals for storage and display together with the static data in an overlaid geographically coordinated fashion so that dynamic data inputted at one user terminal is transmitted to the other user terminals for display with geographically based static data in an overlaid geographically coordinated fashion. The scale of displayed static data may be modified without disturbing its geographic coordination with the displayed dynamic data. All or part of the displayed static data may also be panned without disturbing its geographic coordination with the displayed dynamic data. All or a portion of the displayed static data may be scrolled without disturbing its geographic coordination with the displayed dynamic data. The present invention further contains a method for communicating geographically based by: storing changing geographically based data at a central server, transmitting the stored data to a plurality of user terminals remotely located from the central server and from each other, inputting geographically based data at the user terminals, displaying the stored data and the inputted data at the user terminals, and transmitting the inputted data from one user terminal to the remaining user terminals for display at such remaining user terminals. The method is further capable of transmitting the inputted data from the one user terminal to the central server without passing through the remaining user terminals and transmitting the inputted data from the central server to the remaining user terminals or transmitting the inputted data comprises the step of transmitting the inputted data from one user terminal to the other user terminal without passing through the central server.

### BRIEF DESCRIPTION OF THE DRAWINGS

FIG. 1 is a diagram of the system architecture of the invention showing the three functional subsystems of the present invention and the data flow between them.

FIG. 16 is an example of the location fields included in the “Location” subsection of an “Incident Status” form that might be utilized in a purpose-built Emergency Management Software application.

FIG. 17 is a map illustrating many examples of static map data and dynamic data overlays.

FIG. 18 is a high level illustration of the data flow through the client and server subsystem components during the generation of dynamic overlays.

FIG. 19 is an illustration of the mobile client device acting as a remote server within the system of the present invention.

### DETAILED DESCRIPTION OF THE INVENTION

The following documents are hereby incorporated by reference: U.S. provisional patent application No. 60/211,915 filed Jun. 16, 2000 titled “Distributed, collaborative workflow management software”, U.S. provisional patent application No. 60/228,051 filed Aug. 25, 2000 titled “Distributed, collaborative workflow management software” and U.S. provisional patent application No. 60/271,582 filed Feb. 26, 2001 titled “System, architecture, and method for independently accessing and updating static map data and associated dynamic data in a browser client/server environment”. The following documents, for which filing receipts have yet to be received, are also hereby incorporated by reference: U.S. provisional patent application titled “System, architecture, method and software for creating, updating, and communicating task-specific digital folders of multimedia geographically-referenced information to support mobile field workers in performing their jobs and synchronizing information with computer systems at their base location” filed Feb. 26, 2001 (express mail #ET213924512US) and U.S. provisional patent application titled “Method, architecture, and software for user control, observation, and manipulation of the attributes of selected portions of bit-mapped image files to achieve file size reduction without degrading critical information elements” filed Feb. 26, 2001 (express mail #ET213924852US).

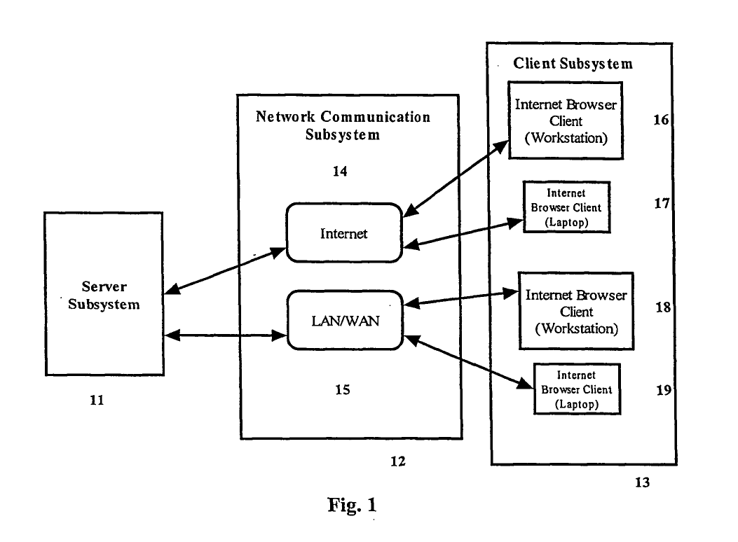

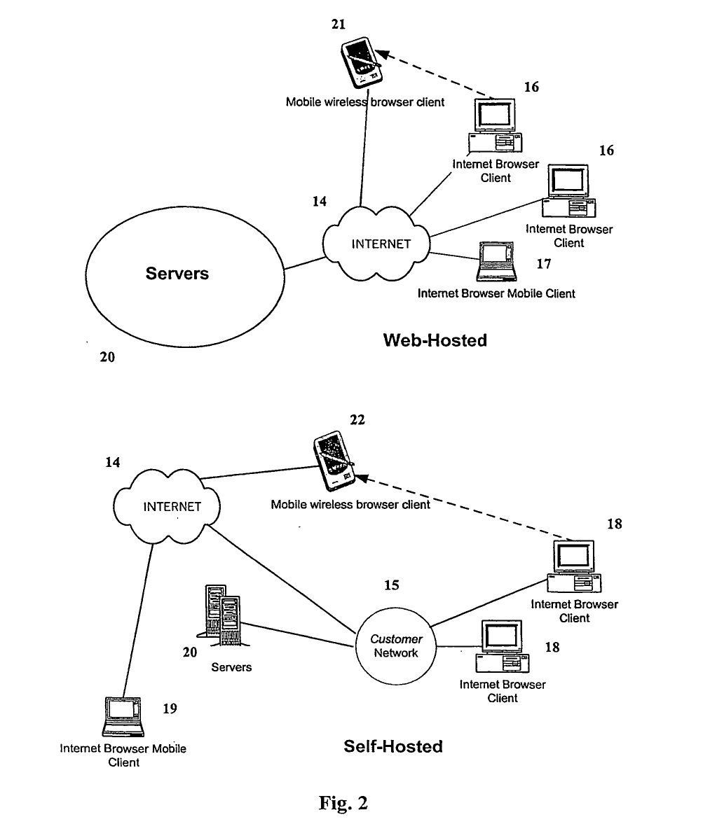

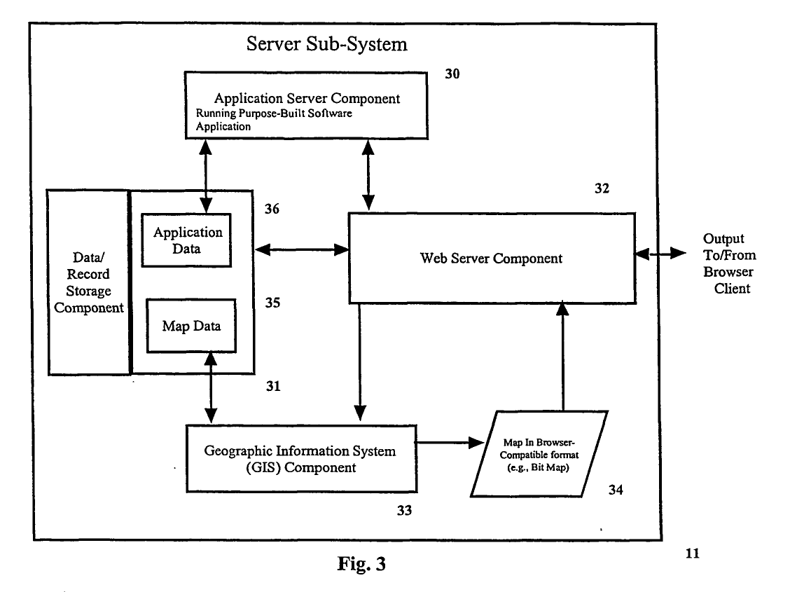

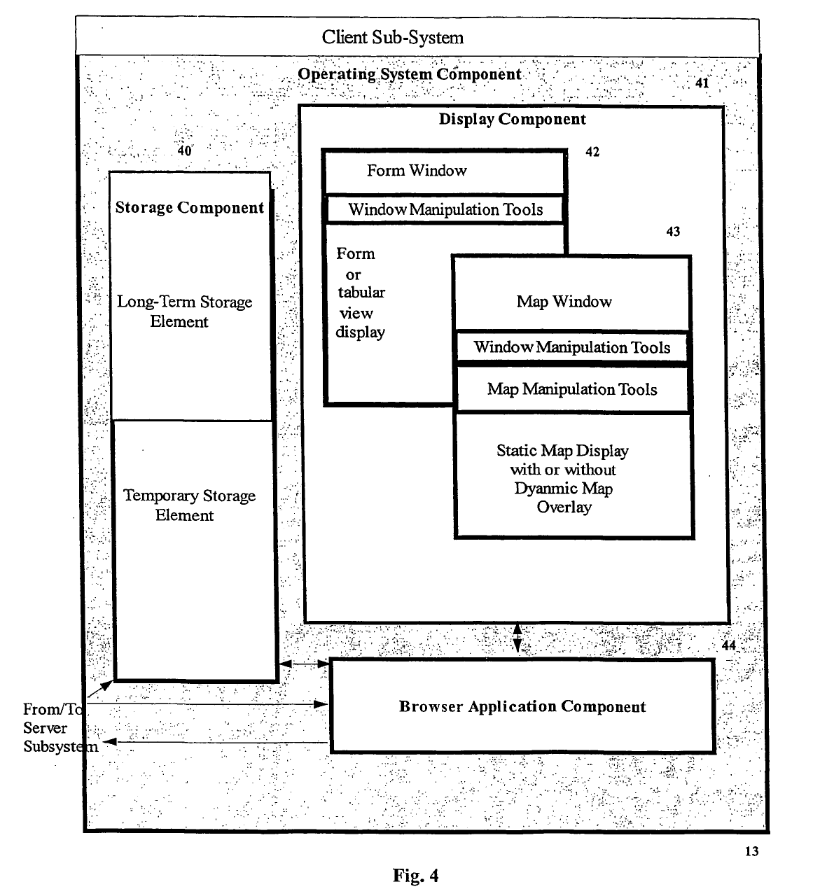

The system of the invention includes three high-level functional subsystems as shown in FIG. 1: a server subsystem 11, a client subsystem 13, and a network communication subsystem 12. Information is stored on and retrieved from the servers (20 shown in FIG. 2) of the server subsystem by devices that are part of the client subsystem. The client subsystem might include, for example, devices such as computer workstations 16 & 18, laptop computers 17 & 19 or mobile wireless clients 20 & 21 (FIG. 2). These client devices communicate with the server subsystem utilizing the network communication subsystem which may be the Internet 14, an intranet 15 or some combination thereof (see generally, FIG. 2). The devices of the client subsystem, in addition to their capabilities as client devices, may also act as additional fixed or mobile servers forming one or more additional server subsystem(s). These additional server subsystems are continuously or intermittently connected to each other and/or other server subsystems within the system of the present invention. Each server subsystem utilizes the data synchronization capabilities of an Enterprise Management or Data Base Management System (“DBMS”) application (in the initial implementation Lotus Domino) to synchronize data resident on the server with that stored on the client devices and other server subsystems. A client device or server may be pre-loaded with a copy of the information stored on one or more servers or it may initially replicate the data stored on the server of to which it is connected when introduced into the system. This flexible system architecture facilitates streamlined ad-hoc management of any conceivable division of duties and resources in the field since servers can be added to the system as necessary and immediately act as coordinators for the management of a particular event, situation, geographic region, resource, etc. While acting in this local coordination capacity, a server updates both client devices connected to it and other servers within the system of the status of the situation and resources under its control. Creation, modification, management, transfer and display of the data managed by the system of the invention is aided by methods related to dynamic overlays (FIGS. 7 & 8), management of geo-referenced multimedia data (FIGS. 6 & 9), document control (FIGS. 10-12) and selective image compression (FIGS. 13 & 14).

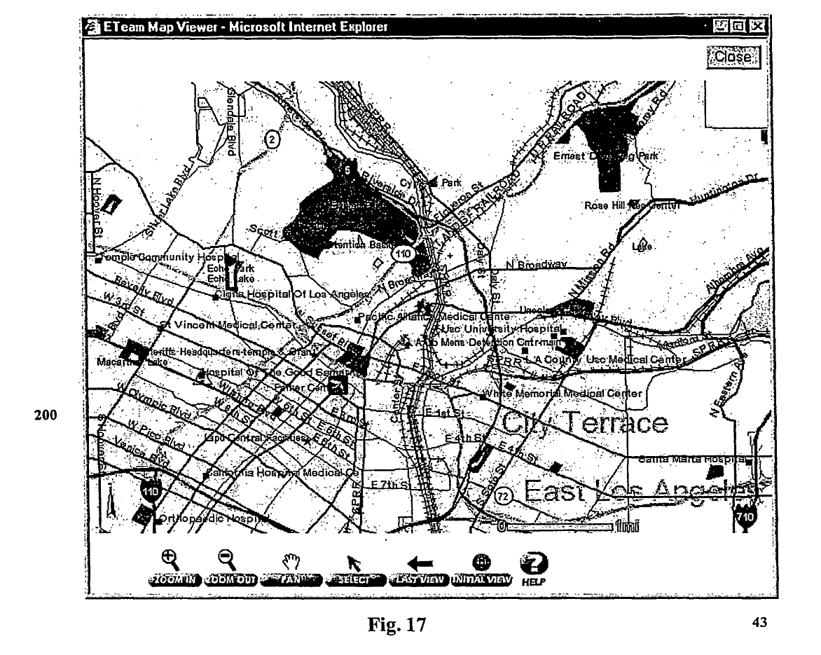

One feature of the present invention is the ability to display, interact with and annotate maps. A client device (e.g., 16, 17, 18 & 19 of FIG. 1 and FIGS. 2, 20, 21 & 22 of FIG. 2 and 123 of FIG. 9) connected to a server can display maps of many different formats such as Shape Files, ADRG, CADRG, etc. which are stored on the client device, the server device or partially on each. A map browser running on a client device can simultaneously display one or more maps similar to the one shown in FIG. 17. The map browser organizes the maps by their geo-spatial locations and by the particular layers of information that make up the map. Layers are the basic display format utilized by the map browser. Individual map files are organized as layers whether the layers overlap each other or not. This layering allows a user to display maps containing different forms of information related to a common area simultaneously. Layers can be moved up or down with respect to each other in support of the performance of analytical tasks or the enhancement of observation capabilities. The map browser offers a set of basic functionality for interacting with maps. This functionality includes zooming, panning, inspecting point information (information referenced to a certain Latitude/Longitude), and generating bitmaps. The generated bitmaps can be used to create files that contain simple or complex images of maps and overlays. A bitmap image of map information can also be used to transfer the map information to an electronic clipboard such as the one supported by the Microsoft Windows family of operating systems. The Windows clipboard is an operating system tool used to transfer data, including images, between applications. A bitmap image stored on the Windows clipboard can be pasted into any application that supports bitmaps such as Microsoft Word.

Each of the aspects of the present invention is discussed in detail in the following sections.

### Server Subsystem

The server subsystem 11 contains one or more server computers along with standard and/or purpose-built software applications which together comprise the four major functional components shown in FIG. 3, specifically: an application server component 30, a data record/storage component 31, a web server component 32 and a geospatial information system (“GIS”) component 33.

FIG. 2 illustrates two exemplary embodiments of the system of the invention. The servers 20 of the server subsystem 11 (FIG. 1) may either be managed by the application vendor and accessed through the Internet 14 as shown in the top portion of the figure or managed by the client and accessed through the Internet 14, client's network 15 or some combination thereof as illustrated in the bottom portion of the figure. Whether the servers are managed by the vendor or the client they may communicate with each other via the network subsystem in order to share, update and synchronize information. The servers may include multiple intermittently connected servers with replicate databases which are synchronized at appropriate intervals or as their connections allow. The network topology may expand and contract as servers connect to and are disconnected from the system.

1.0 An Application Server Component.

The application server component 30 of FIG. 3 is a purpose-built software application running on one or more of the servers of the server subsystem. The application server receives and processes requests from the devices of the client subsystem for information (e.g., forms or maps) to be presented to end users. Requests for and presentation of the information to users of the client devices is accomplished by means of a standard or purpose-built browser application running on the client devices. In the first embodiment of the present invention, the application is an emergency management software application supporting the display of reports, summaries and static map data overlaid with geo-referenced dynamic data in graphical form. Users of this application utilize standard world wide web browser software such as Microsoft's Internet Explorer or Netscape's Navigator to allow users of devices connected to the client subsystem to view and interact with the geographically-referenced information stored on the server. The emergency management application displays map information to end users in a form similar to that of the map shown in FIG. 17. The application server component responds to requests from the client devices by accessing the appropriate component of the server (e.g., the data storage component 31, or the GIS component 33) which provides the data requested by the user of the client device. The server provides requested data, together with appropriate code elements, to the web server component 32 (FIG. 3). The web server component communicates the data to the client device in a format compatible with the application or browser running on the client device (e.g., graphics in bitmap format; code elements as HTML, DHTML, or Java script).

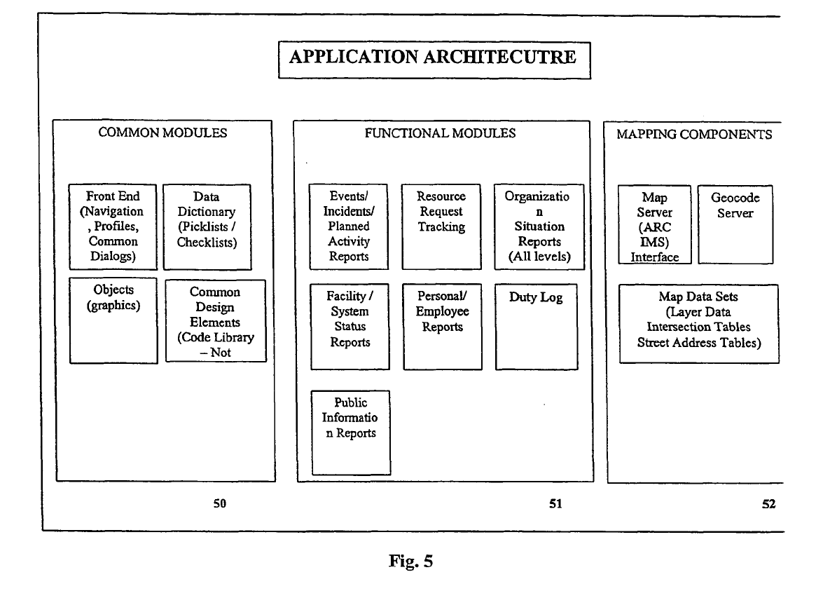

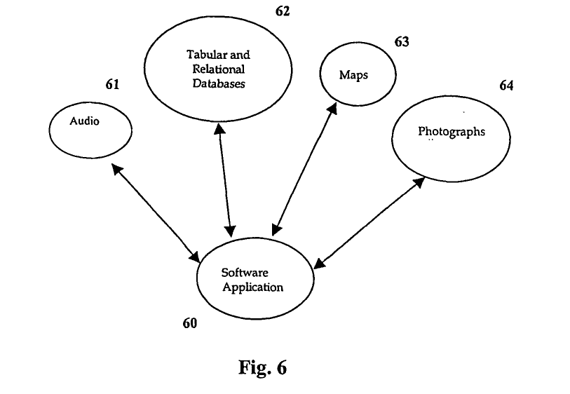

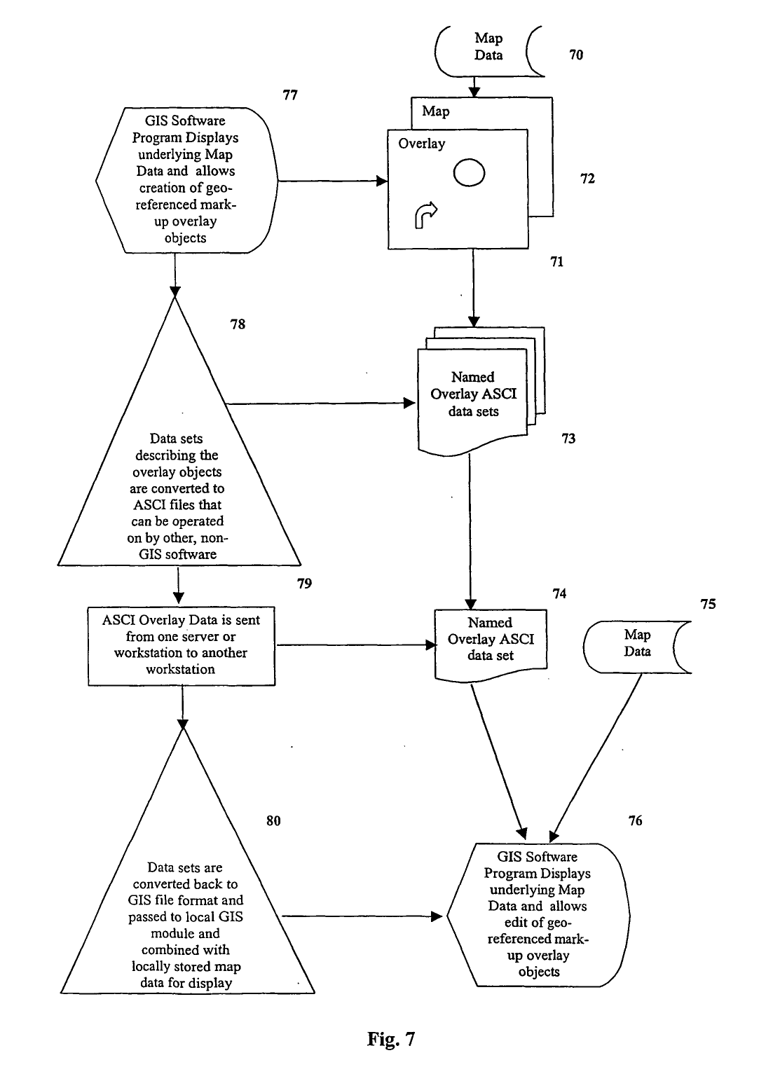

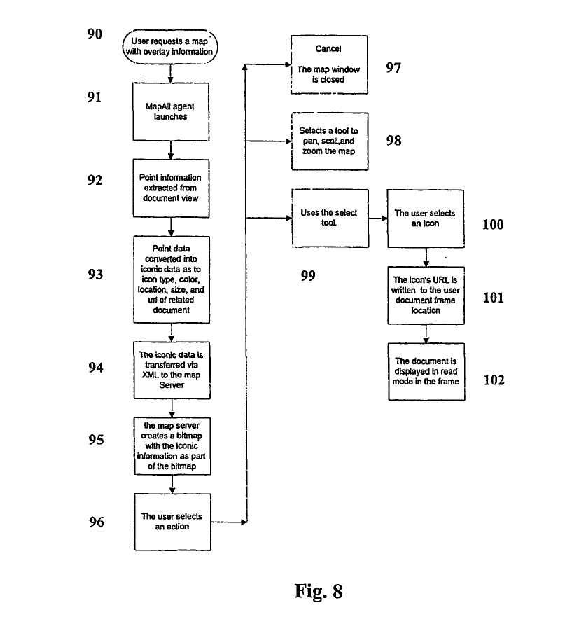

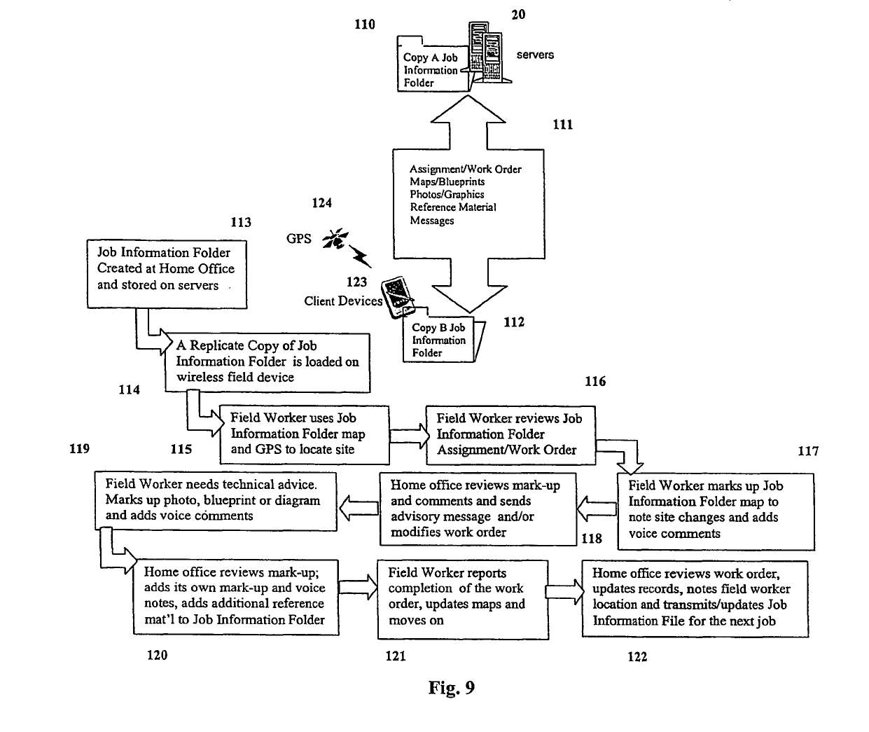

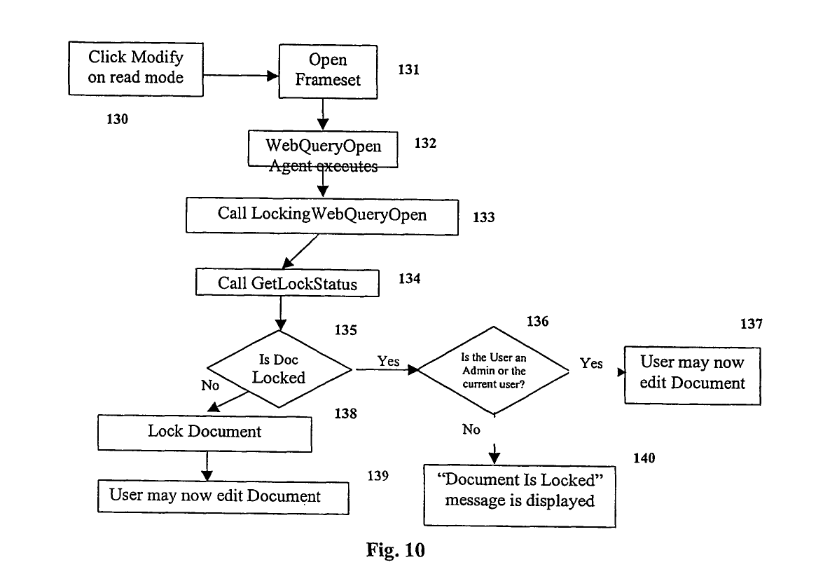

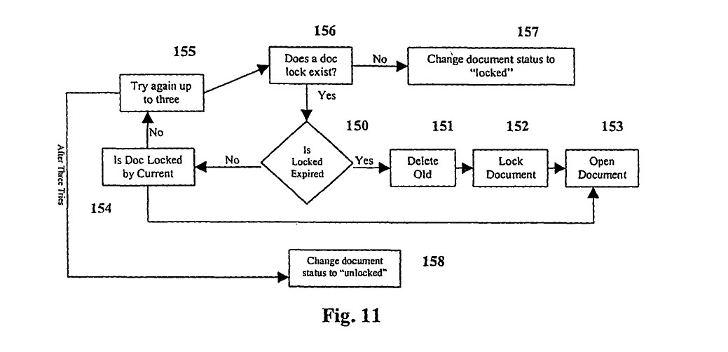

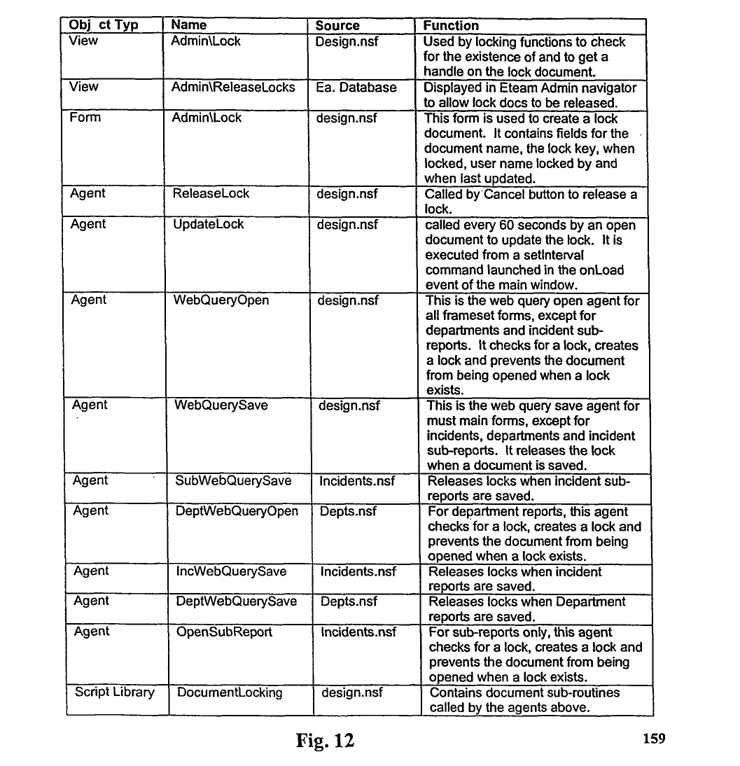

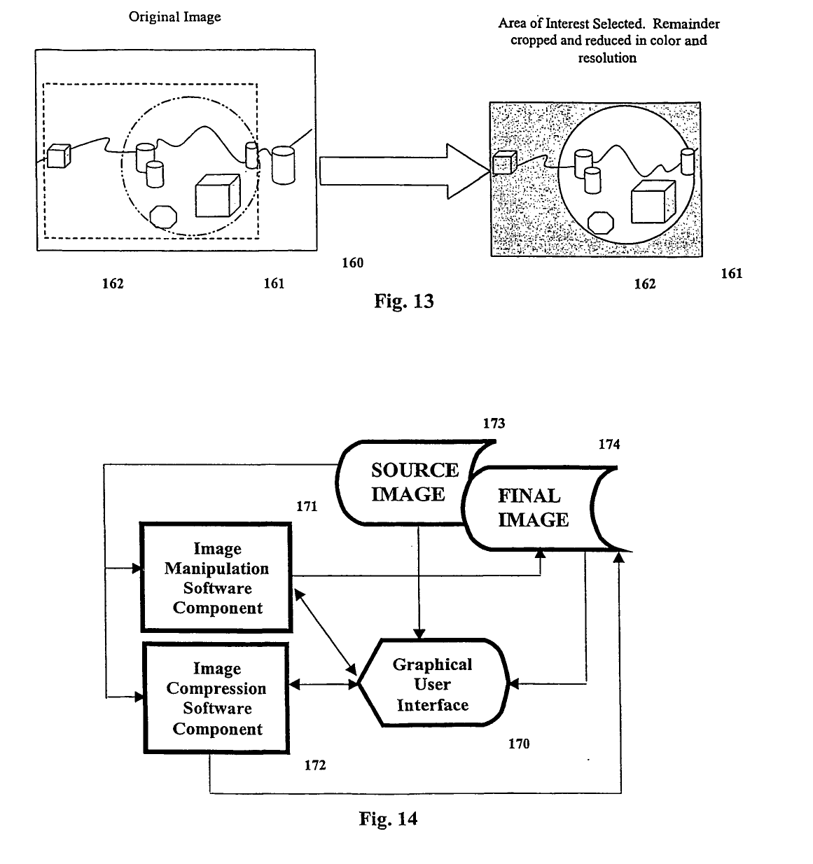

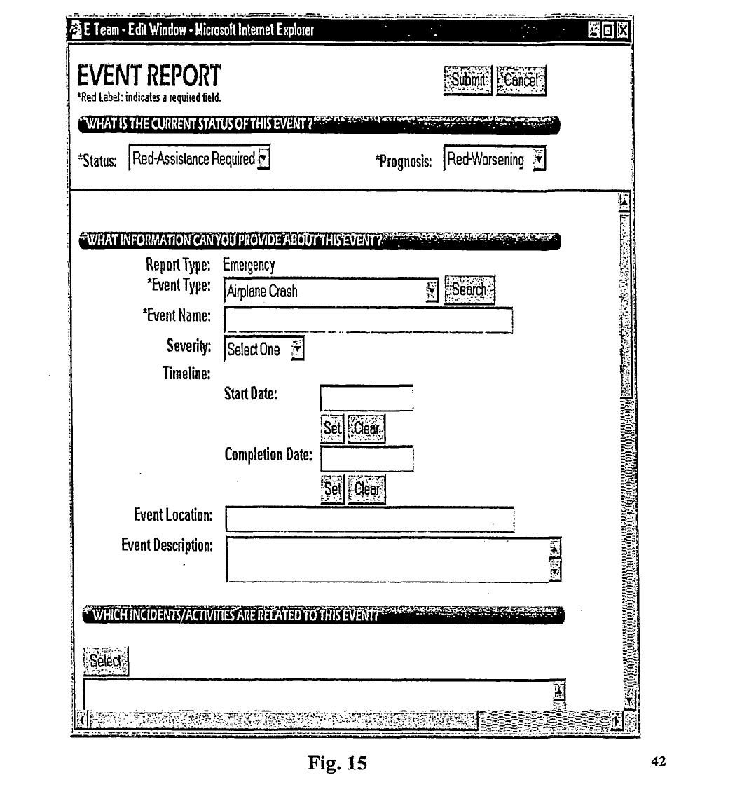

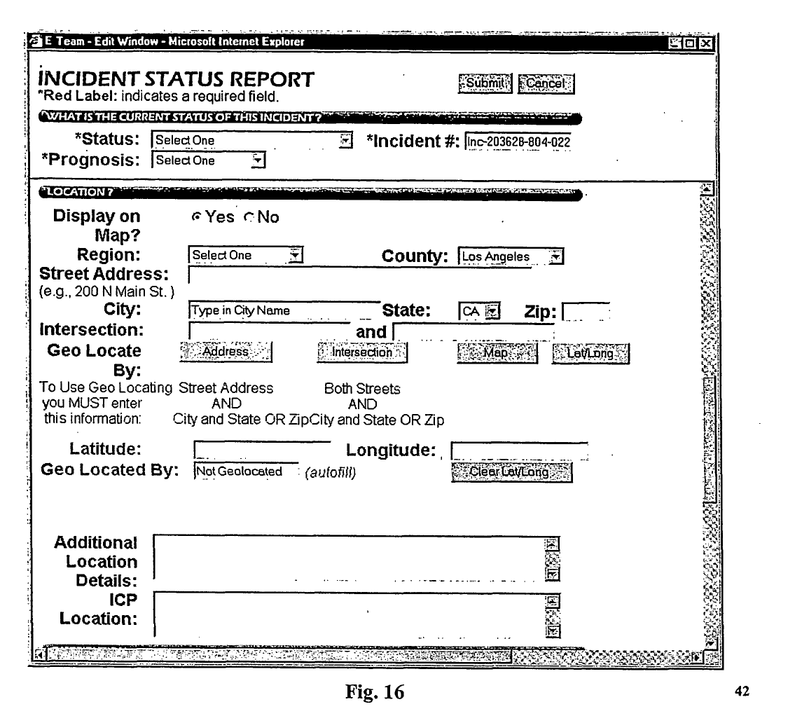

The application server component provides a means for capturing, organizing and storing end user input entered by the user of a client device. Such information is subsequently transmitted back to the server where it is used to create new data records or update existing ones. The information may then be accessed on-demand by users anywhere in the system and propagated to other servers or client devices via the synchronization means provided by Lotus Domino. This information may include data elements that constitute dynamic data to be graphically represented and overlaid on a static map. Dynamic data might include any information that can be geographically referenced such as, for example, the currently reported status of an emergency event or a facility. In one embodiment of this input method, documents, forms or records are presented to the user within the browser application running on the client device. An example of such a form, an emergency incident form utilized in the first embodiment of the invention, is shown in FIG. 16. The form allows a user to enter information describing dynamic situational data by utilizing a keyboard, mouse, touch-sensitive screen or other input device that is an integral part of or connected to a the user's client device. The sample form of FIG. 16 allows the user to input, among other things, the type of emergency incident that has occurred (e.g., airplane crash), the current status of the event (e.g., Red=Assistance Required) and the user's location.

Location information is used to establish a geographic reference for the dynamic data. There are several possible methods of capturing the location of the end user, among them the method in which the user of a client device enters a location directly. This is the approach illustrated by the form of FIG. 16, the user simply enters the desired location into the form as a specific street address, a street intersection or a latitude/longitude pair. Another possible embodiment of the invention involves indirectly determining the user's location by means of a purpose-built geo-locating function operating in conjunction with a look-up table resident on a server. In this instance the client device utilizes a means such as the Global Positioning System (“GPS”) satellite network to automatically determine the user's location. Several other possible embodiments exist including, for example, one in which the user selects the location of an event or facility by indicating a point on a graphical map such as the one shown in FIG. 17.

The application server component 30 also contains a means by which capture of the end user's inputs at a client device indicating what map area and scale the static map are to be displayed. FIG. 17 illustrates an example of user-controllable map manipulation tools (e.g., pan, scroll, zoom, select to view) which the user can use to define the static map image he/she wishes to see, which in turn defines the parameters of the static map image which must be served up by the Server Subsystem.

The application server component 30 further contains code elements supporting several other functions. Among these functions is the definition of the basic parameters of the summary views, forms, maps, and dynamic data defining how each will be displayed graphical format to the end user utilizing a client device. These parameters control properties of the displayed data such as the size and placement of view, form or map windows. Another function supports the operation of the various interactive elements of the view, form and map windows. These interactive elements include: user-selectable buttons which allow the user to navigate through (i.e., request views of) the client subsystem-displayed forms and views (including map views comprised of dynamic data overlaid on static map images); user-selectable buttons which allow the submission, modification and cancellation of forms; and user-selectable map display tools which allow users to pan, scroll and zoom a static map displayed on a client device.

2.0 A Data/Record Storage Component

The data/record storage component 31 (FIG. 3) consists of a means to organize, store and retrieve digital information. The means may be, for example, a computer hard drive or a computer hard drive operating in conjunction with a database application.

The data/record storage component stores the data necessary for execution of the purpose-built software application of the application server component 30, and specifically stores data necessary for creating both static maps and dynamic data to be overlaid on the static maps both of which are displayed by browser software running on a client device. Though the data/record storage component is capable of storing any type of digital information, this information may generally be divided into two broad classifications: map data 35 and application data 36 (both shown contained in the data/record storage component).

The map data represents static or slowly varying information and is stored within the data record/storage component. Map data may contain digital representations of geographic information (e.g., elevation, slope, terrain) and other information that represents certain features which are naturally referenced geographically (e.g. streets, political boundaries, drainage, man-made objects). Though the data is shown stored on a server, it may also be stored on a client device in order to minimize the amount of data that must be transferred to effectuate the desired display of geographically referenced information.

Application data is dynamic data that is stored in the data/record storage component's application data subsection 36 (as shown in FIG. 3) and synchronized among the server and one or more remote servers or client devices. This data may include any type of digital information. Examples of such elements of dynamic data include, without limitation, multimedia documents, graphical elements and data tables.

Multimedia documents may include digital photographs 64, digital audio recordings 61, full motion video, geographic reference/location information 62 & 63 and the like as shown generally in FIG. 6. These documents specifically include documents, forms and records filled out and submitted by users of client devices. The multimedia documents are used by the purpose-built application of the application server component in conjunction with the display of the dynamic information to end users of client devices. For example, a user in the field might take a digital photograph of structural damage to a building resulting from the airplane crash described earlier and transmit the photograph to a server. The photograph is stored in the server's data/record storage component and becomes available to any other server or client device connected to the system.

Graphical elements may include icons and graphic primitives such as lines, points, circles, rectangles, icons or other shapes that have been either pre-created or are created dynamically as necessary. These graphic elements are used as the specific graphical representations of the dynamic data in construction of dynamic data overlays to be displayed by the client devices. The airplane crash described earlier is represented by a pre-defined symbol 200 shown in FIG. 17.

Data tables within the data/record storage component relate the pre-defined or dynamic graphical elements to the situations they represent. One such table would contain an information record defining the airplane symbol 200 as the symbol to be displayed on a client device in conjunction with rendering the particular dynamic data related to the ongoing airplane crash incident. Each graphical symbol further characterizes the situation based on its color. For example, an airplane symbol appearing in red indicates that a user has set the status of the airplane crash event to “red” as illustrated by the form FIG. 15. As the form indicates, a status of “red” means that assistance is required. Thus, end users may obtain a great deal of information from simple graphical symbols with only a glance.

3.0 A GIS Component

The Geographic Information System (“GIS”) component 33 of the server subsystem 11, both shown in FIG. 3 receive requests from the web server component 32 for map images satisfying the requirements submitted by an end user utilizing a client device.

In the first embodiment of the present invention, the GIS component accesses map data stored in the data/record storage component, then creates and outputs to the web server component an appropriate static map image in a browser-compatible format. For example, the GIS component might produce an image in bitmap format which is then transferred to the end user and displayed on the client subsystem. An end user effectively defines the requirements for the map they wish to see by performing certain manipulations at the client device. These manipulations might consist of opening a new map window or panning, scrolling or zooming the map displayed within an already-existing map window such as the one shown in FIG. 17. If the static map or the capability to produce it is not resident on the client device, but is instead served to it by a server, each action by the end user which necessitates a change to a currently displayed static map image initiates another request to the GIS component (via the web server component 32) for a map meeting the newly defined requirements.

Another possible embodiment of the invention includes a GIS component that initially and/or occasionally loads either the entire set or a predefined subset of the static map data onto the client devices utilizing the application server component and data stored in the data/record storage component. This embodiment allows for more efficient use of the bandwidth available to client devices in light of the fact that the static map data is typically represented by one or more large data sets. The efficiency gain stems from performing data synchronization intermittently when excess bandwidth is available within the system. This implementation yields an advantage for mobile wireless client devices 20 & 21 (FIG. 2) as they will typically be connected to the servers by low or moderate bandwidth links and thus would experience long transmission delays if the static data were transmitted only on command or repeatedly every time a new view was requested.

4.0 A Web Server Component

In response to requests from the client devices, the web server component 32 of the server subsystem 11 (FIG. 3) interprets the requests, obtains inputs as appropriate (e.g., data and code elements) from the application server component 30, the data/record storage component 31, and the GIS component 33. These inputs are then packaged for transmission to the requesting client device and communicated to it in browser-compatible format. For example, when the original Police Officer arrived on the scene of the airplane crash she requested a map of the area via her client device. This request triggered the web server component to request a map from the GIS component, and code elements necessary to properly display the map (e.g., HTML code, DHTML code, Javascript) from the application server component. The application server component also provides any necessary dynamic information and code elements necessary to geo-register the dynamic information on an underlying static map image from the application server component. In the instant case the dynamic information relating to the airplane crash was already present in the system along with the necessary code elements to locate the icon representing the crash on the map image returned by the GIS subsystem. In turn, both the GIS component and the application server component retrieved the necessary data from the data/record storage component and returned this data to the web server component. The web server component packaged the map image, dynamic data and code elements for transmission to the client device that originally made the request and initiated the transmission using an Internet-compatible communications protocol (e.g., HyperText Transfer Protocol—HTTP). In some embodiments the static map data is already resident on the client device and only the dynamic data and any necessary code elements are actually transmitted from the server to the client during the web server component's fulfillment of the client device's request. The requested map appears in a map window on the client device as illustrated by FIG. 17.

Client Subsystem

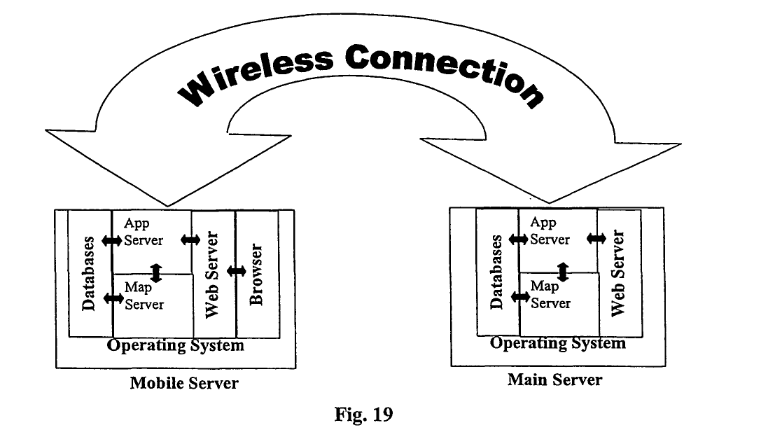

The client subsystem 13 shown in FIG. 4 consists of one or more networked client devices acting as user terminals each of which contains a computer processor and at least some of the following functional elements: a storage component 40, a display component 41, a browser application component 44 and an operating system component 45. As illustrated by FIG. 19, any device of the client subsystem may also act as a server (and therefore as part of the server subsystem) so long as it contains the necessary components of the server subsystem.

1.0 An Operating System Component

The operating system component 45 of the client subsystem, as in any conventional computing device, provides the environment in which the other functional components operate. Typical operating systems include variants of Microsoft Windows, Linux, Palm OS and the like.

2.0 A Storage Component

The storage component 40 includes a short-term or temporary storage element wherein inputs to the client subsystem from a server may be stored before being subsequently interpreted and rendered by the browser application component 44. In this temporary storage element, static map data (and its, constituent elements including graphical data elements such as map images and code elements needed to facilitate the display of the data elements) are stored. In the first embodiment of the invention clients normally display the information using Microsoft's Internet Explorer. The static map data resident on a client device can be updated independently of dynamic data in graphical form (and its constituent elements, including graphical data elements such as icons, x/y location data, and code elements necessary for the display of the data elements). Data and code elements not directly related to the rendering and display of the static map and dynamic data in graphical format, such as those necessary for the rending and display of forms and tabular views, are also stored in the storage component 40 as they are received from the server. All of the data and code elements are subsequently made available to the browser application component 44 for rending and display.

Note: The “data” portion of the dynamic data in graphical format (e.g., the icons) can be refreshed whenever new dynamic map data is available. The purpose-built software of the application server component 30 resident on the servers 20 (FIG. 2) of the server subsystem 11 (FIG. 1) can be designed and configured to “push” new dynamic data to the client devices (either as it becomes available or at pre-determined time intervals). The application server component may also be configured to “pull” (provide on demand) new dynamic data from the server in response to an end-user-initiated action (e.g., pressing of a “Refresh” or “Update Map Data” button or scrolling the map to an area that contains dynamic information not already displayed).

3.0 A Browser Application Component

Browser and browser-like applications are standard or special-purpose application programs that effect the requesting and the displaying of web pages provided by the servers 20 (FIG. 2) of the server subsystem 11 (FIG. 1). Examples of standard commercial browser applications are Microsoft's Internet Explorer and Netscape's Navigator. The browser application component 44 of the a client device receives input either directly from a server or indirectly from a server via the storage component 40 of the client device. The browser application utilizes its inherent capabilities to interpret and render the data and code elements provided it by the web server component of the server subsystem. Specifically, the browser application may create and display documents (e.g., forms or tabular views) and/or a static map with or without an overlaid set of dynamic data in graphical format.

More specifically, with respect to rendering a form window 42 (see e.g., FIGS. 15 & 16), the browser application component may render: window manipulation tools which allow the end user to control the opening, closing, sizing, etc. of the window in which the forms are displayed; form manipulation tools which allow the user to interact with displayed forms (e.g., via rendered “Submit”, “Cancel” or “Modify” buttons which appear on the form and are usable by the end user); and the forms and tabular views themselves.

When rendering a map window 43, the browser application component may render: window manipulation tools which allow the end user to control the opening, closing, sizing, location etc. of the map window in which the static maps and/or overlays of dynamic data are displayed; map manipulation tools which allow the user manipulate the displayed static map image (e.g., pan, scroll, zoom, or select an object to view); and the static map itself, with or without an overlay of dynamic data in graphical form.

Alternatively, a browser-like application such as a Lotus Notes client, may access information stored locally on a client device and periodically synchronize that information with its counterpart on a server via either a wired or a wireless connection.

4.0 A Display Component

It is through the display component 41 shown in FIG. 4 (e.g., a conventional computer monitor or flat panel display) that the end user actually views the information rendered by the browser application component of a client device. The capabilities and features of the display component (e.g., color capability, gray scale capability, resolution) will affect the overall amount of information content conveyed to the end user.

Network Communication Subsystem

The network communication subsystem 12 shown in FIG. 1 provides connectivity between one or more servers of the server subsystem 11 and one or more client devices of the client subsystem 13. This connectivity may be accomplished via any one of a number of communications links, including communication via an intranet (a Local Area Network (“LAN”) or a Wide Area Network (“WAN”)), the Internet or some combination thereof. Since the client devices each run a software browser application, transmissions between the client subsystem to the server subsystem will typically utilize the HTTP communication protocol. Transmissions from the server subsystem to the client subsystem will be in browser-compatible format.

In the case of mobile, intermittently connected devices the network communications subsystem may be a direct-to-server telephone modem or network interface or a modem connection to an Internet Service Provider and thence, via the Internet, to a server. In such cases the interchange will typically be TCP/IP data exchanges in the formats specified by the specific synchronization software. Initial embodiments of the present invention utilized Lotus Notes and/or Arc Pad to perform the synchronization.

Integration and Cross-Referencing of Multimedia Data

In order to support the mobile wireless business processes, an enabling client-side software application was designed utilizing object oriented techniques for software development. Each component of the software application was designed as an object that performs specific functions, and interfaces with other objects to accomplish complex tasks. Techniques and tools of the Microsoft Foundation Classes (“MFC”) were employed as a framework to implement the first incarnation of this aspect of the present invention. The basic framework of the application is designed within a document/view architecture commonly used to implement MFC based applications. The main concept behind this architecture is that data is contained in documents and that there are many possible views of the data which allow it to be inspected and edited.

The software application described in this section utilizes many types of data. For example, the application manipulates report information which is contained for the most part in text-based or word processor files stored in a database. It also displays maps and overlays which can be contained in files of many different formats such as shape files, CADRG files, JPEG images, etc. Further, it accommodates digital photographs and digitally sampled voice files. Each type of data mentioned above normally demands a window that specifically adheres to the viewing and editing capabilities supported by the file and data format contained therein. One benefit to implementing the application in a framework based on the Microsoft Foundation classes is that a single application can manage many data types with many viewing and management requirements within a single common interface.

The MFC framework also offers a large number of utility objects designed to facilitate the design of window applications. The application that enables this aspect of the present invention utilizes many of these objects to: interface with data files, display information, and provide the controls necessary to manage this information.

In addition to the MFC framework, the application integrates other commercial, off-the-shelf software libraries and applications. Two libraries used in the first implementation are the Microsoft Windows CE Software Development Kit (CESDK), and the ESRI Map Objects 2.0 Software Development Kit (MO2). The CESDK provides mechanisms for viewing, editing, and transferring files between the two types of systems and was used to support the interface between the PC and the mobile wireless clients (e.g., Palm PC systems). The MO2 library is used to support mapping and imaging functionality within client devices. It allows an application to view images and maps stored in many formats and overlay data created by users of client devices in the field. Such overlay data will typically be displayed over maps or photographs shared by both PC s, servers and mobile wireless devices. Other map, photographic manipulation, and/or computer operating systems may be incorporated in later variants to perform the same processes.

The enabling application provides a database comprised of several data tables. These tables are categorized as either permanent or transitory data tables. Permanent data tables are those were the data stored in them is for the most part static such as the static map data referred to earlier, this static data is typically must be present for the proper operation of the client devices. The transitory tables only purpose is to aid in the transfer of information between a server and a client device's (here a mobile wireless device's) database files. Information within each transitory table is operated on internally by a server-side application and externally by an application resident on the client device (in the initial implementation the Visual CE Synchronization manager). The client-side application works in association with forms on the mobile wireless device to exchange information between the server and mobile device's databases.

1.0 Components of the Multimedia Cross-Referencing System and Method

The main purpose of the job information management software is the management of information collected by field operatives on their mobile client devices. The application is divided into four main functional categories: job management, report management, map/overlay browsing, and image/annotation browsing. These categories are described in the following subsections.

2.0 Job Information Manager

The Job Information Manager (“JIM”) centralizes all functionality offered by the mobile device application. All data related to a specific job is correlated by a job number or job ID. The JIM is responsible for creating the job ID, and for keeping together all data components related to the a specific job ID. It does this by creating a job folder referenced by the job ID and placing files related to a specific job in one location as illustrated in FIG. 9. The job folder has the same name as the job and job ID. The job ID may be defined, for example, by a date, time, and number associated with the specific job. The job information folder 110 and 112 is created either on the server 11 or the client device 123. The job information folder contains all of the information 111 related to a specific job. This information might include, for example, work orders, photographs, voice annotations, blueprints, messages, situation reports, emergency management forms or any other type of information related to the job or situation for which the folder was created. In one embodiment of the present invention the job information folder 110 is created at step 113 on the server when a client device is assigned a job. A copy of the job information folder is subsequently transferred from the server to the client device by the JIM through the network communication subsystem 12 (FIG. 1) during step 114. Where the client device is equipped with means to geolocate itself using the Global Positioning System (“GPS”) a user may optionally execute step 115 of the process described by FIG. 9 and utilize GPS to locate either the user's own position or a job site specified by the information stored in the job information folders (110 or 112).

3.0 Reports Manager

The application allows for the creation, editing, and distribution of job reports. Each type of report has a dedicated window that interfaces with the database to store and retrieve report information.

The creation of reports is a function of the client device. Normally, a user will be assigned a specific job or jobs and given a mobile device that is contemporaneously or previously configured using the Job Information Manager and the process of FIG. 9 described above. The client device might contain maps, photos, existing reports, and any other data relevant to the job(s) at hand (see e.g., the information 111 of FIG. 9). After reviewing the information contained in the job information folder during step 116 of the process shown in FIG. 9, the user proceeds to the job site. Upon reaching the job site or at any time thereafter, the user may carry out step 117 by collecting or creating additional information and inputting it into the client device and the job information folder. Information input into the client device by the end user will typically, for the sake of convenience, be collected and stored through the use of predefined data forms though any type of data (e.g., a voice annotation, digital photograph, text file, etc.) may also be input into the client device and job information folder without the use of a predetermined form. Where forms are employed to speed data entry and classification, each form corresponds to a specific type of report, samples of two such forms appear in FIGS. 15 & 16. FIG. 15 depicts a sample “Event Report” form while FIG. 16 contains a sample “Incident Status Report” form. At one or more points during the data entry process of step 117 or upon its completion, the JIM accesses the client device and may retrieve all or a portion of any newly collected data present there. Where the JIM retrieves newly collected data from the client device, it does so by utilizing a communications link provided by the network subsystem. Data retrieved by the JIM is typically stored in a database resident within the data/record storage component of the server. In this manner, the JIM manages the synchronization of the job information folder 110 on the client device with the job information folder stored on the server. The newly collected information now resident on the server immediately becomes available to all users of client devices connected to the system of the present invention. Utilizing the document control process described later in conjunction with FIGS. 10-12 said information is controlled in such a manner that other users may not only access and review it but annotate, correct or otherwise modify it in the face of a rapidly changing situation to which the information is related. For example, at step 118 of the process shown in FIG. 9 the user's home office might comment on or modify the newly transmitted information now present on the server. Following an update of the job information folder in step 118 the JIM may resynchronize this job information folder with the user's job information folder. Should the user and/or the home office have questions when information is added to either of the job information folders (110 and 112) by the other party, the process proceeds optionally through the iterative steps 119, 120 and 121 whereby each party communicates with the other through updates to the information contained in the job information folders. Upon completion of the current job the process proceeds to step 122 wherein the home office initiates the process again via the creation of a new job information folder.

4.0 Map Browser

The server-accessible map browser works in conjunction with the mobile client device's mapping capabilities. The client device allows a user to view maps and create mark-up overlays. A server operator as part of the job planning typically selects appropriate maps and downloads them to the end user's client device. The end user in while the field may then use these maps to identify their own location, identity and any other relevant information. The user may also create mark-up overlays to indicate status, performance, or other information related to the job. Upon completion, overlays (but not the underlying static map data) are uploaded from the client device to a server via the network subsystem along with any other files created with respect to the job. Any user with access to the server may then view and analyze the user's field data and observations (generated as overlays) by using the map browser of his or her own client device.

5.0 Photo Browser

The photo browser borrows much of its functionality from the map browser (except for geo-referencing features). The photo browser supports various image formats such as JPEG, TIFF, Bitmaps, Mr. SID, etc. Zooming and panning are available along with the capability to generate bitmaps from any displayed image. The photo browser also adds two important features related to the informational content of photos. It features the ability to display ink annotations (free hand sketches) over the photograph image, and also the ability to play voice annotations related to the image.

As photographs are collected, the mobile device uses a commercially available photo manipulation application that allows users to index and annotate photographs. The annotations are typically “ink” (hand-drawn) annotations and/or voice annotations. Ink annotations are saved in a proprietary file format file while the voice annotations are saved as wave files. The files created usually have the same name as that of the original photograph file. Hence, when they are uploaded to the server, the application will automatically detect their existence and enable easy access to them. To facilitate viewing the mark-up annotations, they are normally converted to shape tiles. The server automatically performs all file detection and conversions.

6.0 Voice Annotator

Voice annotations are available to the user by means of a commercial-off-the-shelf multi-media application. The application is used to play the wave files collected from the mobile device.

7.0 Database

The server portion of application requires database support to manage report and mission information. A commercial, off-the-shelf database, such as Microsoft's Access may be used. The database is composed of permanent tables and temporary tables. Permanent tables are, for the most part, static since they store completed reports and mission parameters, which, once created, are rarely modified. In addition, permanent tables are those the user interfaces with. Temporary tables are used to exchange information between the databases on the server, and the database files on the mobile client device when the latter is being prepared for a job. Temporary tables, as the name implies, contain data for very short periods of time. With each modification, before they are filled with information, the entire table is erased. Hence, only the desired data is transferred between the two systems. Upon completion of a mission, a user will connect the mobile client device to the server through a standard interface software and hardware that come with the mobile device. Following a successful connection and synchronization, the server will upload all files created as part of the job information folder to the mobile device. It is at this time, that the data collected in the database files on the mobile device will be exchanged between the temporary database tables (which contain the mobile device database data), and the permanent tables. Matching records are checked for changes, and new records will be created on the permanent tables to store the new information.

Once the mobile client device is connected to the server, an automatic synchronization process commences. This is performed by a commercial off-the-shelf software application, in the first embodiment of the present invention this application is Lotus Domino. This synchronization application is launched automatically upon a connection to the mobile device. It extracts all data from the database forms resident on the mobile device and stores it in the temporary database files. The data will remain in the temporary tables until the user transfers it to the permanent tables.

Dynamic Map Information

1.0 Posting Icons to the Map and Accessing Reports from a Map Display

The mapping components of the present invention represent a unique blend of enterprise software and geographical map presentation. With these components, a user is able to create a document, locate it on a map geographically, see an iconic representation as a layer on a base static map, and then, via selection of that icon display the corresponding source document(s). In addition the icon's inherent properties, color, symbol type, and size may be varied depending on the data contained within the document. This functionality is available entirely via the web utilizing a standard web browser application. The components used in this process comprise: enterprise server software (in the first implementation of the present invention, The E Team application implemented by Lotus Notes Domino server), an Internet map server (in the first implementation, ESRI's ArcIMS Internet map server and ESRI's Map Objects), Java servlets, JavaScript, HTML, and Visual Basic.

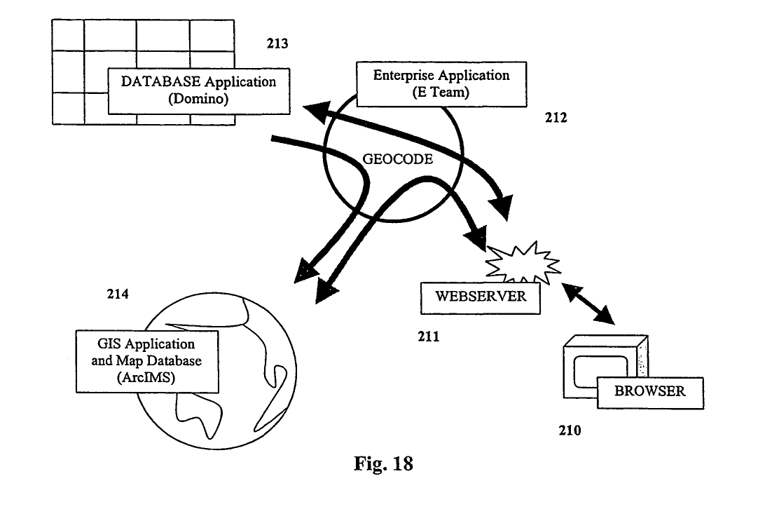

FIG. 18 illustrates the system architecture supporting the process by which the software components of the client and server subsystem interact to support the generation and display of graphical maps. The user first creates a report then enters a location by entering a latitude/longitude pair directly, by entering a street address, by entering street intersections or by indicating a location on a map display. This location data is stored in a record of the data/record storage component 31 of the server subsystem 11 as shown in FIG. 3 at this or a later time. The report may correspond to, for example, an incident (see FIG. 16) which is to be geographically referenced and indicated on the map display by an icon or a simple action such as a pan or zoom operation that modifies a currently visible map display.

One method of static map image retrieval begins when a user selects a map to display or requests that a currently displayed map view be modified via input to the browser 210 running on the client device. The enterprise application software 212 retrieves the required data from the report resident on the client device by utilizing the inherent communication capabilities of the web server 211. The enterprise software application then stores the record in the database application 213 and formats it such that the GIS application 214 (here an ESRI ArcIMS server) can understand it In the first embodiment of the present invention, the GIS application then generates a bitmap image in a suitable file format and transmits it to the client device where the browser displays the map image in the user's map window.

Retrieval of the static map information may also be accomplished by the process outlined above where the transfer of data from the GIS component of the server subsystem (here ESRI's ArcIMS Internet map server and ESRI's Map Objects) via the web server consists of only dynamic overlay data and not an entire static map image. In this instance a user creates a report via the browser application running on the client device. The report is again sent via the web server to the enterprise application which formats the request such that the GIS application will be able to understand it and stores it in the database application (storage component of the server subsystem). The request is then sent to the GIS application which determines where the dynamic data overlay is to be placed and returns any necessary graphics and browser code to the browser application of the client device. In this instance, an underlying static map image is generated in the browser application's map window via a query of static map data already stored in the storage component of the client device . The data is subsequently combined with the data and code elements retrieved from the GIS application of the server subsystem and displayed along with an iconic indicator (representing the report) as a graphical map with iconic overlays at the appropriate locations on the map as illustrated by the sample map image of FIG. 17.

When a user clicks on a dynamic overlay icon, JavaScript code executed within the browser application component detects mouse clicks on the map window (shown in detail in FIG. 17), compares the point indicated by the mouse click against a list of geographic regions, determines if any document is associated with the indicated region, then communicates with the server subsystem to display the indicated document.

Separate purpose-built mapping components which are not part of the GIS subsystem (ArcIMS) but operate in conjunction with the enterprise application (Lotus Domino) furnish the user with the ability to enter an address, then interrogate the geocode server. The geocode server is a component of the server subsystem resident within the enterprise application and database components that determines an appropriate latitude/longitude pair for a selected location and returns it to the user as a display in the browser window. The user, for example, may enter a street addresses or street intersections via a data entry form (see e.g., FIGS. 15 & 16). Where the user enters only a simple street name or street intersection with no further information, the geocode server may find many matching entries and subsequently attempt to return them to the user. For example, a user entering 100 main street in the state of California could easily match over 100 entries. In cases such as this where a large number of entries are found the geocode server filters the “hits” that are returned to the user depending on the user's indicated city or zip code.

A system generated overlay (also referred to as a “dynamic overlay”, “iconic overlay” or “tactical overlay” in other portions of this document) is a graphical element that overlays a map background map with iconic information. The iconic information specifies particular information to the user of a client device via the icon's particular properties such as shape or color. As a user pans, scrolls, and zooms the map display each icon maintains its relative geographic reference. The geographic reference for the icons is obtained through the process of geolocation, described below.

Icons displayed as system generated overlays are selectable via a mouse click or similar action to launch the display of any document(s) associated with the selected icon as described above. In the first embodiment of the invention the documents were stored in the data/record storage component as Lotus Notes documents which, when selected by the user, display information related to a particular geographically referenced event represented by the icon that was selected. The icon's type, its color, point size, and similar information indicate the type of data it represents.

FIG. 8 illustrates the process of generating and displaying dynanic overlay data. The process begins with the user requesting a map and related overlay information. When the user's request is complete the process proceeds to step 91 whereby a software application (step 91 identifies this application as the “MapAll” agent) begins running on the user's client device. The software application then proceeds to step 92 and extracts point information corresponding the user-selected event and geographic reference from the display in either the form window 42 or the map window 43 (both shown in FIG. 4). After the point information is extracted, it is converted to iconic data (e.g., icon type, color, location, size, URL of specified document) at step 93. During step 94, the iconic data is transferred to the server subsystem and subsequently used along with any other necessary information retrieved by the server subsystem to create a map image in bitmap format to fulfill the user's request The user then proceeds to step 96 from which point they may choose to cancel their pending request (step 97), select a map manipulation tool (step 98) from the map window, or select the selection tool (step 99). If the user at step 96 selects the selection tool by proceeding to step 99 the user may then use the selection tool to select an icon from the graphical display (see e.g., FIG. 17). At this point the URL associated with the icon the user selected in step 100 is loaded into the form/document window 42 of the user's client device and is displayed according to step 102.

2.0 Mark Up Tactical Overlays

The present invention's software system architecture includes support for the creation, storage, retrieval and manipulation of geographically referenced dynamic data overlays in such a way that they can be transmitted between any devices of the client subsystem 13 and/or the server subsystem 11 without including other (static) map data in the transferred information. Further, the overlay can be displayed atop any map that contains the geographic coordinates at which the original overlay was placed, not just the particular map data set over which it was initially created. Finally, the overlays can be attached to documents and operated on by enterprise management and DBMS software, independently of other map data and outside of the GIS software in which the map data resides. Information elements in the overlay can therefore be included in tabular displays and information input as tabular or ASCII data can be used to update the overlays.

The first embodiment of the present invention includes an overlay drawing module that presents tools to the user that allow the creation of an “electronic acetate sheet” geo-referenced to an underlying static map display. The user may place on that sheet lines in various styles and colors, closed areas with fill patterns in various styles and colors, alphanumeric labels, pre-defined iconic symbols or hand-drawn annotations as illustrated by the process of FIG. 8 which was described above. The invention also has overlay extraction capability whereby the data on the overlay is captured in the form of a data set and stored as a retrievable file separate from the static map data files as that are described in conjunction with FIG. 7 below. A software method that attaches the overlay to documents in the overall distributed collaborative information management software application, is also described in conjunction with FIG. 7 below. The server subsystem 11, particularly the application server component 30 (FIG. 3) can then operate on an overlay in the same manner it operates on any other document or data set, storing, sorting, and routing the overlay as appropriate.

FIG. 7 is a graphical depiction of the process by which geographically referenced mark-up overlays are created and utilized. Step 77 of FIG. 7 shows a stored map data set at one workstation displayed by GIS software that allows the user to create a superimposed overlay. The overlay data is then translated to ASCII files external to the GIS software program and operated on by other modules of the information management system in step 78. The small ASCII files representing the dynamic mark-up overlays can then be passed to other workstations as shown in step 79, where they are translated back to GIS format and passed to a GIS software component that combines them with (step 74) and geographically references them to (step 76) locally stored map data. The resultant combination is then displayed in the map window 43 (FIG. 4), which the user can view or edit via a set of map manipulation tools (contained in 42 of FIG. 4 and as illustrated by FIG. 17).

The application architecture detailed in FIG. 5 supports the digital acetate overlay functionality described above and incorporates a commercial off-the-shelf or purpose built GIS component 33 as shown in FIG. 3. This allows end users at computer terminals to select and view map information, to include selecting which map layers are to be displayed and manipulating the displayed portion of the map by panning, scrolling (moving the centroid of the displayed portion to the left or right and or up or down) and zooming (changing the scale of the displayed portion while keeping the same centroid). The architecture further includes a set of tools that allow an end user to create, annotate, store, retrieve and exchange with other users tactical overlays, the electronic equivalents of sheets of acetate, that are geo-referenced to but separate from the underlying map data over which they are drawn. These tools allow the annotation of the “electronic acetate” with lines, closed areas, alphanumeric characters, and graphic elements. All annotations are variable by color; area annotations may include automatically generated fill patterns; alphanumeric characters are variable in a variety of font faces and type sizes, and graphic elements may be selected from a pre-stored palette and annotated with alphanumeric characters above, to the sides, and below. Information created as input to the tactical overlays can be passed to other modules of the distributed, collaborative information management system, so that geographically referenced information entered on the overlays can be posted to databases for subsequent tabular or graphic display; other modules of the system can pass location data that was entered in tabular form to the GIS component as an overlay file. The GIS component may then display these overlay files as in a geographically referenced manner on an underlying map display. Nodes of the distributed, collaborative information management system that are connected to the server over low bandwidth data links (e.g., the mobile wireless clients 21 & 22 of FIG. 2) may pre-store static map data in their local storage components 40 (FIG. 4) and exchange only the much smaller overlay data, which may then re-combine with locally stored static map data for display and manipulation.

Dynamic Document Locking and Unlocking

FIG. 10 illustrates the document locking process wherein each time an existing document is edited or a new document created, a document lock is created, attached to the document and associated with the particular user who is editing the locked document. A key that uniquely identifies the document and document lock is also generated. In most cases, the key is the unique document ID, both departments and incident sub-reports are exceptions that are locked upon creation and therefore do not have a document ID. Instead, the department name or form name and incident number are used, respectively, as the lock's key. Together, the document lock/key pair act to ensure that only a single user may edit the locked document at any given time.

FIG. 10 is an overview of one possible embodiment of the document locking process. A user first takes an action in step 130 that initiates the document opening process. The process proceeds to step 131 which opens a frame to display the requested document. Step 132 initiates a software application (the “WebQueryOpen” Agent) that manages the document retrieval process. The WebQueryOpen Agent calls a WebQueryOpen method in step 133 which in turn calls the GetLockStatus method of step 134 (discussed in detail in conjunction with FIG. 11). The method then determines whether the requested document is currently locked (step 135). If the requested document is not locked, a new lock is created and attached to it (step 138) and the document is returned to the user in editable form (step 139). If a valid lock associated with the requested document is found in step 135, the method determines whether the document has been requested by the user who currently has it locked or an administrator (step 136). If either the owner of the current document lock or an administrator is requesting the document, the method proceeds to step 137 and the document is returned to the user or administrator in editable form. However, if the method determines in step 136 that the document is locked and the requesting party is not the user who currently owns the document lock or an administrator, the document remains locked and a message to that effect is displayed by step 140. The functionality described in conjunction with the overview of the document locking method of FIG. 10 is found within the document locking script library and is accessed via the web query open agent.

1.0 GetLockStatus Algorithm

FIG. 11 is a flowchart that describes in detail the GetLockStatus method used to determine if there is a valid lock on a requested document. Generally, the GetLockStatus method allows users to access the document in editable form in the event that a current lock on the document appears to be invalid.

The GetLockStatus method begins at box 156 of FIG. 11 wherein the method determines if the requested document is currently locked. If the document is not currently locked, the method proceeds to box 157 and sets the status of the requested document to “unlocked”. After step 157 has completed, execution of this method continues at step 138 of FIG. 10. If it is determined in step 156 that the requested document is currently locked, the GetLockStatus method proceeds to step 150 which determines if the current lock has expired. If the current lock has expired, the method proceeds to step 151 which consists of deleting the existing expired lock. Step 151 is immediately followed by step 152 and 153 which are identical to steps 138 and 139 (both shown in FIG. 10) respectively. If step 150 had determined that the current lock on the document had not expired, execution of the GetLockStatus method would have proceeded to step 154 which is identical to step 136 of FIG. 10. Should step 154 find that the document has been requested by the user who owns the current lock on the document or by an administrator, execution proceeds to step 153 which is identical to step 137 as described in conjunction with FIG. 10. However, if within step 154 it is determined that the document has been requested by a user other than the user that owns the current lock on the document or an administrator, the method proceeds to step 155 which restarts the GetLockStatus method by proceeding to step 156. After the GetLockStatus method traverses steps 156, 150, 154 and 155 three times, the method proceeds to step 158 which marks the document as being locked by the requesting user. Following step 158, execution would continue with step 137 of FIG. 10.

2.0 Timeout Feature

A timeout feature updates the status of a document lock every 60 seconds utilizing some of the design elements shown in the table graphically depicted in FIG. 12. If a document lock exists that has not been updated in the preceding three minutes, the lock is considered expired when tested in step 150 of the GetLockStatus method. In one possible embodiment of the present invention this feature is implemented in JavaScript running within the browser application component 44 (FIG. 4) of a client device (e.g. computing devices 16-19, 21 & 22 of FIG. 2) of the client subsystem 13 (FIG. 4) works as follows: A one-pixel wide lock frame at the top frame of each editable report is created along with the report view. The Javascript onLoad event of the main form view 42 shown in FIG. 4 runs an updateLock( ) method whose code is associated with the lock frame described above. The updateLock( ) method calls a setInterval( )method that sets the URL of the lock frame to be periodically checked in order to verify the continued existence of a lock associated with a given document (the lock frame's location) and the frequency with which the lock frame will be checked (as described herein the interval is 60 seconds though any length of time is possible). For example, this URL: /<current db>/UpdateLock?openagent&id=<lock key>, where current db identifies the database in which the document is stored and lock key uniquely identifies the document being edited, causes, in the present embodiment, an UpdateLock Lotus script agent to be run every 60 seconds.

The UpdateLock script agent performs the following tasks: The agent parses the lock key from the URL that initiated execution of the agent then uses this lock key to get a handle on a lock document that corresponds to the locked document. After verifying that the handle on the locked document still exists (i.e., that the user has not closed the locked document on the client device thus removing the corresponding lock document from the server subsystem) the agent updates a LastUpdated field of the lock document to the current system time of the computer system (server 20 of FIG. 2) upon which the agent is running. The agent then saves the lock document on the server and awaits another request from the user, the agent does not send any output back to the user.

3.0 Release Lock Feature

After a user finishes editing the document they began editing following step 137 of FIG. 10, the document is typically submitted to the server through the use of a means specially designed for that purpose. In one embodiment of the present invention the means of submission takes the form of a the submit button similar to those shown on the sample forms shown in FIGS. 15 & 16. When the submit button is pressed, the Web Query Save agent calls the ReleaseLock method from the document locking script library, passing it the document ID and/or a lock key that corresponds to the document being submitted. In this manner, the ReleaseLock method obtains a handle on the lock document and deletes it thus freeing the previously locked document so that it can now be edited by other users.

When Cancel is pressed, the ReleaseLock script agent is called by setting the location URL of the main document frame to the following URL:

/ReleaseLock?OpenAgent&id=<doc ID>&cancelpressed

This causes the agent to call the ReleaseLock method from the document locking script library, passing it the document ID and/or a lock key that corresponds to the document being canceled.

### Selective Compression

1.0 Overview

Another aspect of the present invention supports user control, observation, and manipulation of images to achieve reduction in the size of the files in which they are stored. More specifically, this method conveniently incorporates existing tools that allow translation of image formats, reduction of image resolution, reduction of the number of colors, cropping of the image and the application of compression algorithms. These tools are coupled with the ability to define any part or parts of the image to which the changes are to be applied. All of this is done for the purpose of reducing overall image file size while retaining higher resolution for key information elements. Thus, a user can manipulate a digital photograph, for example, by selecting a portion (perhaps a certain object or objects) of the photo that is to retain the highest resolution and color density. The remainder of the photo is selected for reduction in resolution and color depth. Thus, the entire image remains available for context, but only the elements of the image that are of importance to the sender or recipient are rendered in detail. Via this process, the size of a file in which a digital image or photograph is stored may be greatly reduced facilitating the efficient transmission of the resultant image over low or moderate bandwidth communications links such as those employed by mobile wireless users. Mobile users, such as repairmen, emergency responders, medical personnel and the like, can exchange graphical images, especially photographs and complex drawings with their home bases to both update the home base as to conditions in the field and to draw from the home base those images they need to perform their tasks while creating less demand for memory resources on their client devices, less demand for bandwidth on the network subsystem and less demand for long-term storage resources on the server subsystem. The image manipulation process is centered around user control and observation of the image manipulations. The process begins with the user performing the manipulations of an image on a computing device via a purpose-built software application with a graphical user interface (“GUI”). As each manipulation is performed, the user directly observes the results of the manipulations and judges their efficacy for the intended purpose(s). For example, the user's purpose in reducing the data file size of a digital photographic image may be to minimize transmission time, while maintaining acceptable differentiation between similar objects in the image. By selecting among available file size reduction alternatives and observing the resultant image, the user can select those manipulation(s) that best achieve the desired purpose prior to transmitting the image. The method begins with a user accessing or creating a digital image which is displayed to as illustrated by the original image 160 shown in FIG. 13. When this image becomes available to the user the method then proceeds through a number of steps, each of which is optionally performs in any order. The user may optionally change the format in which the image is stored to one that inherently offers greater compression. For example, the user may be presented with an image in bitmap format and choose to change the format of the image to JPEG thus employing the compression scheme of the JPEG standard to reduce the size of the resultant image file.. The image may be cropped to further reduce the size of the resultant image file. File size reduction associated with cropping is due to a reduction actual amount of information stored in the image file since the area of the image that is cropped is discarded. Resolution and color depth of the image may also be varied, both of which result in a lessening of the amount of information that must eventually be stored in the image file. The GUI of the purpose-built image manipulation software allows the user to conveniently select one or more portions of the image by employing a drag-and-drop action that defines, for example, a rectangle, oval, or freehand outline as the selected portion of the image. The selected and unselected portions of the image may then be manipulated by any of the steps described above. During the image manipulation process, the user observes the resultant reduction in file size, and the expected transmission time for a specified available transmission bandwidth and may iteratively repeat one or more steps of the method to balance these factors as desired. Finally, the user saves the resulting image as a new file which may be locally stored or transmitted to any server or client device connected to the system

### Utilization of the Invention

In a typical embodiment of the system, method, and architecture of the invention, its utilization might consist of the following processes.

The end user at a client device of the client subsystem signs on via the browser application or a browser-like equivalent, such as Lotus Notes, if he or she is operating in a mobile, intermittently connected mode and accesses a purpose-built application program (such as an Emergency Management Software application) that runs on a server of the server subsystem. The application includes navigational tools (e.g., button and menu), forms, and map views selectable by the user.

The user selects a desired form to create or modify, (e.g., an emergency event form). The selection action (e.g., pressing of a “Create Event Form” button) causes a request to be sent via the browser application from the client subsystem to the server subsystem to retrieve the requested form. This form is communicated back to the client subsystem and is subsequently displayed to the user. The form comes up in a form window that can be sized or moved by the user (using the standard window manipulation tools). The user then proceeds to input data (e.g., name of event, date/time of event) into the fields of the form, including that data which constitutes the “dynamic data” (e.g., event “Type”, event “Status”, event “Location”) intended to be subsequently extracted by the server subsystem, translated into graphical representations, and overlaid on a static map.

When the user has completed his input, he clicks on the “Submit” button located on the form. This triggers the execution of locally-stored code which causes the browser to “send” the form to the server subsystem. These filled-in forms are stored in the storage component of the server subsystem. Contained in the filled-in forms are those key textual data elements which constitute the dynamic data that can be subsequently accessed by the server subsystem's application server component and translated into appropriate graphical overlay information, at such time as the user chooses to call up a map view requiring the display of such overlaid dynamic data.

The user, wishing to see a graphical map-based summary view of the current situation (as captured by, and extracted from, the data collected on some sub-set of all of the Forms submitted to the Emergency Management System), clicks on a navigator menu (e.g., button) that defines the map view he wishes to see; for example, a map-based view of all events that have been previously reported (shown as graphic icons overlaid on a map). In order to “open” a map window containing the selected map view, the browser component of the client subsystem must issue a request to the server subsystem to provide the appropriate static map image and accompanying dynamic data overlay. This initial request for display of a map typically calls for display of the map at a default geographic extent and zoom level as set in the special-purpose. application running at the server subsystem.

The application sever component running on the server subsystem receives the request for the map view via the web server Component. It then performs a pre-defined translation to determine what stored forms it must access (in this case all previously submitted “Emergency Event Forms”) and what data elements it must extract from these forms (e.g., the type, status, and location data elements) in order to create the requested dynamic view. It then examines the dynamic data elements contained in all of the stored event forms (e.g., “Type”, “Status”, and “Location”) to determine what graphical elements (e.g., icon shapes and colors) it will have to retrieve from the storage component to support subsequent client subsystem rendering of the dynamic overlay. It retrieves these elements from the storage component and passes them to the web server component, together with the necessary code elements to support subsequent rendering of the dynamic overlay, and its proper geo-registration with the static map over which it will be overlaid. It also passes code elements which will allow the client subsystem's browser application to render a “Hot Spot” invisibly overlaid on each displayed dynamic icon so that if the user chooses to click on the icon, the user will see displayed the underlying event form whose dynamic data caused the icon to be displayed. Note that when the user clicks on the icon “Hot Spot”, the code associated with the “Hot Spot” triggers and causes a request to be sent to the server subsystem to serve up the associated form.

The user chooses to leave his/her chosen map window open, while performing other actions in the purpose-specific application (e.g., filling in other forms). Meanwhile other users accessing the same emergency management software on the same server subsystem are also accessing and filling in forms, reporting on new events and updating the status of existing ones. In the embodiment of the system being described for illustrative purposes, the purpose-specific application running on the server includes code which provides for the automatic creation and sending of new dynamic overlay information to the client subsystems each time a new form is created or an existing form's dynamic data fields are updated. Such an embodiment can be described as implementing a “push” system for communicating dynamic data updates from the server subsystem to the client subsystems. The application software could just as easily be configured to provide “push” updates of dynamic data at pre-set timed intervals, or to support “pull” updates initiated by end user inputs at the client subsystems (such as clicking on an “Update Data” button). With any of these “push” or “pull” methods, the dynamic data updates are rapid because only the relatively small graphical elements (e.g., icons) and associated code elements must be transferred to the client subsystem, not the large static map information (e.g., data and code). Because of the “push” update method implemented in the embodiment being described, the user benefits by always seeing presented in his map window, the most current event situation.

The user now decides to see what events are, occurring in a particular city on the map, but must pan, scroll, and zoom the map to bring the geographic area of interest into the center of his map window. He uses the map manipulation tools to pan, scroll and zoom the map display. Each time he performs one of these actions, a new request must be sent from the client subsystem to the server subsystem to retrieve and supply the appropriate new map image displaying the appropriate geographic area at the appropriate scale. These static map updates take longer than the dynamic overlay updates because the amount of information (e.g., graphics and code) to be transmitted is much greater.

As the event situation develops, the client user can submit new situation data via forms, request a complete refresh of both static map data and dynamic data, request an update of only dynamic data, or request a zoomed, panned or otherwise re-oriented static map with its corresponding dynamic data.

Because all end users are interacting with the same emergency management application on the server subsystem, and posting their data through this application to a common storage component (the equivalent of a “White Board in the Sky”), each user has the benefit of being able to request and view an up-to-date composite graphical representation of the current situation overlaid on a map, and then access more detailed underlying form data, as desired.

Throughout this document reference has been made to source code, scripts, HTML and other code elements that comprise a portion of the present invention. To aid one skilled in the art in understanding the operational aspects of the present invention, a detailed user's guide for one embodiment of the present invention named “V1-5 E Team Gov Edition User Guide O-6-8-01.doc” is also included in the CD-ROM Appendix.

Specific examples have been used throughout the description to illustrate the features and capabilities of the present invention. One skilled in the art would recognize that numerous modifications and departures may be made from the specific embodiments described herein without departing from the spirit and scope of the claimed invention.

1. A Method for communicating geographically based data comprising the steps of:
storing geographically based static data at a user terminal;
storing geographically based dynamic data at the user terminal;
displaying the static data and the dynamic data together in an overlaid geographically coordinated fashion; and
repeatedly transmitting updated dynamic data to the user terminal for storage and display together with the static data in an overlaid geographically coordinated fashion.

2. The method of claim 1, additionally comprising the steps of pointing an input device at a landmark of the displayed static data and displaying data about the landmark together with the static data and the dynamic data in an overlaid fashion.

3. The method of claim 1, in which the step of storing geographically based dynamic data at the user terminal comprises storing dynamic data received at the user terminal from a central server.

4. The method of claim 3, in which the step of storing geographically based dynamic data at the user terminal additionally comprises storing dynamic data inputted at the user terminal.

5. The method of claim 4, additionally comprising the step of:tansmitting to the central server the dynamic data inputted at the user terminal.

6. The method of claim 5, additionally comprising the step of transmitting from the central server to other user terminals the dynamic data transmitted to the central server.

7. The method of claim 6, additionally comprising the steps of:
storing geographically based static data at the other user terminals;
storing geographically based dynamic data at the other user terminals;
displaying the static data and the dynamic data together in an overlaid geographically coordinated fashion at the other terminals; and
repeatedly transmitting updated dynamic data to the other user terminals for storage and display together with the static data in an overlaid geographically coordinated fashion so that dynamic data inputted at one user terminal is transmitted to the other user terminals for display with geographically based static data in an overlaid geographically coordinated fashion.

8. The method of claim 1, additionally comprising the step of changing the scale of the the displayed static data or a part thereof without disturbing the geographic coordination with the displayed dynamic data.

9. The method of claim 1, additionally comprising the step of panning the displayed static data or a part thereof without disturbing the geographic coordination with the displayed dynamic data.

10. The method of claim 1, additionally comprising the step of scrolling the displayed static data or a part thereof without disturbing the geographic coordination with the displayed dynamic data.

11. A method for communicating geographically based data comprising the steps of:
storing changing geographically based data at a central server;
transmitting the stored data to a plurality of user terminals remotely located from the central server and from each other;
inputting geographically based data at the user terminals;
displaying the stored data and the inputted data at the user terminals; and
transmitting the inputted data from one user terminal to the remaining user terminals for display at such remaining user terminals.

12. The method of claim 11, in which the step of transmitting the inputted data comprises the steps of transmitting the inputted data from the one user terminal to the central server without passing through the remaining user terminals and transmitting the inputted data from the central server to the remaining user terminals.

13. The method of claim 11, in which the step of transmitting the inputted data comprises the step of transmitting the inputted data from one user terminal to the other user terminal without passing through the central server.

14. The integration of web based enterprise management system and a GIS system to generate, store, retrieve, and display info, either textually, tabularly, or on a map.

15. A method of coordinating the operations of a web browser client, a web server, an enterprise management server application, and a GIS server application, so as to allow browser input and retrieval of geo-referenced information in a multitude of formats by a large number of geographically separate, persistently connected browser clients.

16. The method of claim 15 additionally comprising the step of integrating mobile, intermittently connected clients using browser-like clients.

17. The method of claim 16 additionally comprising the steps of:
separating static and dynamic data in the enterprise management and GIS systems;
and storing replicates of the static data on the mobile, intermittently connected browser-like clients so that only dynamic information needs to be exchanged with the server-based application.

18. The method of claim 17 additionally comprising the steps of:
creating geo-referenced icons and polygonal graphics representing dynamic information outside of the GIS system;
linking the geo-referenced icons and polygonal graphics to enterprise management system documents; linking the geo-referenced icons and polygonal graphics to displays, properly positioned and scaled, over the underlying map display produced by the GIS system.

19. A process of using the system of claim 14 to create and support ad-hoc groups of geographically separate, web browser-connected users and mobile, intermittently connected users in inter-agency, inter-jurisdictional teams, giving them computer access to virtual operations centers, data sharing environments that provide and update a common operational picture presented on demand to any connected client in either geographic, tabular or text displays; this process being used to manage and coordinate planned and unplanned incidents and events.

20. The method of claim 19 further comprising allowing web browser-connected users and mobile intermittently connected users to access and change the content of data records without conflicting with each other, and of ensuring that data records checked out by one person for edit do not remain inaccessible to others for longer than a system-specified interval.

21. A process of using the System of claim 14 in the manner of claim 19 to support the management of electric power outage notification further comprising the steps of:
coordinating the inputs of Utility providers and government agencies; and providing targeted information to browser-connected public and private entities, based on their inputs of points of interest, both geographically, to show what areas are or may be affected, and by direct notification.

22. A process of using portions of the system of claim 14 in a Job Information Manager function that allows a tasker to put together a folder of integrated, multi-media job information, including maps, photos, directives formats and reference data, download the folder into a mobile, intermittently connected device and provide the device to a person who takes it to the field to execute the jobs specified. Once in the field, the worker uses the methods of claims 14 and 17 to operate on the data and keep it synchronized with the information in the Enterprise Management server application.

23. A method of reducing the size of graphic files in the mobile segment of the system of claim 22 by selectively manipulating the resolution of various parts of an image, its colors, and the overall size of the image, seeing the effect of these operations on information content and file size in real time.
